(19) United States
(12) Patent Application Publication
(10) Pub. No.: US 2025/0116115 A1
(43) Pub. Date: Apr. 10, 2025

(54) LIFTING MECHANISM FOR SCISSOR ATTIC STAIRS, ATTIC STAIRS, AND METHOD OF LIFTING ATTIC STAIRS USING A LIFTING MECHANISM

(71) Applicant: FAKRO PP SP. z o. o, Nowy Sacz (PL)

(72) Inventors: Bernard KACZMARSKI, Piwniczna Zdrój (PL); Boguslaw KASINSKI, Limanowa (PL); Bartlomiej MOS, Nawojowa (PL)

(73) Assignee: FAKRO PP SP. z o. o, Nowy Sacz (PL)

(21) Appl. No.: 18/907,933

(22) Filed: Oct. 7, 2024

(30) Foreign Application Priority Data
Oct. 9, 2023 (PL) P.446327

(51) Int. Cl. E04F 11/06; B66F 3/44; B66F 11/04

(52) U.S. Cl. CPC E04F 11/066; B66F 3/44; B66F 11/04

(57) ABSTRACT

The subject-matter of the invention comprises a hoist mechanism for attic scissor stairs, attic stairs and method of hoisting attic stairs concertina ladder using hoist mechanism, wherein the hoist mechanism with an electric drive is constructed out of load bearing frame (5), half-frame (62) with electric drive (72) suspended from it, and half-frame (61) is constructed out of lateral stile (61) and two side stiles (62), so that half-frame side stiles (62) are mounted using articulated joints to load bearing frame (5) wherein each side stile (62) features lifting system (13) for lifting attic stairs concertina ladder (3), wherein lifting system (13) assumes a passive and an active position during hoist mechanism operation.

The subject-matter of the invention comprises a hoist mechanism for attic scissor stairs, attic stairs with that mechanism and a method of hoisting attic stairs ladder using a hoist mechanism.

Attic stairs have been disclosed under P.442139 which in particular feature a concertina ladder which may be folded and unfolded using a drive system.

Stairs with an electric drive by Henzs have also been disclosed and they may be purchased at the following auction: https://www.alibaba.com/product-detail/Remote-Controlled-Electric-Attic-Folding-Stairs_1600317613115.html. These stairs feature a half-frame with an extension arm in the form of a spring, which supports the concertina ladder during stairs unfolding and helps with raising and compressing the concertina ladder when folding the stairs. Therefore, the extension arm is in its active position at all times.

The subject-matter of the invention comprises a hoist mechanism with an electric drive for attic scissor stairs, wherein the hoist mechanism according to claim 1 is responsible for the stairs' concertina ladder compression when folding the said stairs. The hoist mechanism features a lifting system which features two positions, an active position and a passive position, so that in defined conditions it acts on the stairs ladder in a discontinuous manner. The subject-matter of the invention also comprises attic stairs with a hoist mechanism according to claim 11 and a method of hoisting attic stairs ladder using the hoist mechanism according to claim 17.

The attic stairs fitted with hoist mechanism are constructed out of a box designed to be seated in a building partition opening. The box is closed from the bottom using a closing hatch. The attic stairs drive assembly is responsible for opening and closing the closing hatch as well as for unfolding and folding the stairs concertina ladder. The drive assembly features an actuator driven by an electric motor, a gear system, and drive assembly operation is controlled via a controller operated remotely, using a remote control for example. The hoist mechanism is constructed out of a load-bearing frame with the stairs closing hatch suspended from it and a half-frame with the electric motor and drive assembly actuator suspended from it. The half-frame is constructed out of a lateral stile and two side stiles. The half-frame side stiles are mounted using articulated joints to the load bearing frame, wherein each half-frame side stile is constructed out of at least two sections at an angle of α≤180° relative to each other, and the concertina ladder and the half-frame joint is articulated. Preferably the articulated joint between the concertina ladder and the half-frame includes a hoist spigot. Each half-frame side stile also features a lifting system, which assumes a passive position and an active position during hoist mechanism operation. In the lifting system active position, the force lifting the concertina ladder is greater than zero and in the passive position that force is equal to zero and the lifting system is not active. Preferably the lifting system is built like an extension arm with two ends which feature longitudinal openings. One end of the extension arm is attached to the half-frame side stile using at least an articulated joint, and the other end of the extension arm is attached to the concertina ladder using at least an articulated joint. Preferably the said joints are articulated and sliding joints. A sliding joint means that the joint between the extension arm and the concertina ladder and/or between the extension arm and the half-frame side stile preferably features a spigot which may travel in an appropriate extension arm end longitudinal opening during hoisting and lowering of the attic stairs concertina ladder until it reaches an extreme position so that the distance between these spigots changes during hoist mechanism operation. The maximum range of change in the distance between the spigots is defined by an extreme spigot position in the extension arm longitudinal opening. In the spigots' extreme position, in the opening, the spigots are flush with an edge in the appropriate longitudinal openings. The spigot in the extension arm and concertina ladder joint is referred to as the support spigot. When the support spigot is in an extreme position in the extension arm opening, and there is also a spigot between the extension arm and the side stile, that spigot is also in an extreme position in the opposite extension arm opening, so that these two spigots are at a maximum distance from one another.

The joint locations between the half-frame and the lifting system, i.e. extension arm with concertina ladder, split the concertina ladder into three section which are known as section one with its lower boundary defined by the side stile and concertina ladder joint location which preferably features a hoist spigot, section two between that location and the joint between the extension arm and the ladder, which preferably features a support spigot and section three with its upper boundary defined by the location of the joint between the extension arm and the concertina ladder. Attic stairs, which also feature a locking mechanism, which is a sub-assembly of the closing hatch drive assembly, feature the hoist mechanism described above. The locking mechanism features at least a coupler and a coupler cable fastened to a closing hatch bracket. The coupler cable terminates with a ferrule and the cable passes through an opening in the closing hatch bracket. The concertina ladder is suspended from ladder base, wherein the ladder base is attached to box side walls, and the bottom box closing hatch features brackets for top and bottom closing hatch suspension flat bars. Top suspension flat bars, with the stairs open are closer to the box than the bottom suspension flat bars. The attic stairs also feature a load bearing beam attached to attic stairs box side walls and the drive assembly is suspended from the load bearing beam. Whereas the closing hatch is suspended from the load bearing frame via bottom suspension flat bars, and from the load bearing beam via top suspension flat bars. The aforementioned load bearing frame features a lateral upper stile, which is a ladder base, and the stairs feature a support beam located between the closing hatch and the load bearing frame and the support beam is suspended using tie-rods on box side walls. The attic stairs drive assembly is located between the load bearing beam it is attached to and the half-frame lateral stile, and the coupling element located between the drive assembly and the lateral stile changes the position of the ladder relative to the load bearing frame as a result of drive assembly operation.

Hoisting the attic stairs ladder is achieved through a hoist mechanism in accordance with the following stages:
preparation of the stairs in an open position, where the stairs ladder is unfolded using the drive assembly, wherein in the unfolded position, the lifting system assumes any position relative to the attic stairs, preferably spigots, where one spigot is a support spigot, located in actuator arm end longitudinal openings assume any position therein,
hoisting the attic stairs ladder through a hoist mechanism driven by a drive assembly,
during the first hoist stage the ladder is raised at the support point constituting the location of the joint between the ladder and the half-frame leading to a compression of the concertina ladder, wherein the compression along the first section of the ladder is greatest, and distance between the location of the joint between half-frame side stile with the lifting system and the location of the joint between the lifting system and the concertina ladder tends towards and achieves maximum value permissible by the lifting system specification,
during the second hoist stage, concertina ladder compression degree along its first section and second section in particular increases as compared to the first hoist stage, and distance between the location of the joint between side stile and lifting system and the location of the joint between lifting system and concertina ladder achieves its maximum value permissible by the lifting system specification. Preferably during the second hoist stage, the lifting force resting on support spigot is greater than zero, as opposed to the first stage where the lifting force resting on support spigot is zero. After the second hoist stage, the closing hatch shuts the box, leading to a complete folding of attic stairs.

The illustration depicts the invention, with given figures depicting the following:

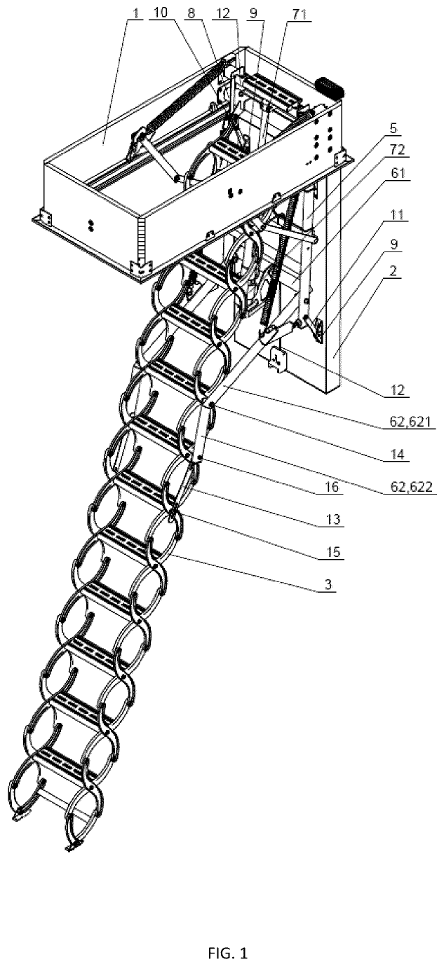

FIG. 1 attic stairs with hoist mechanism,

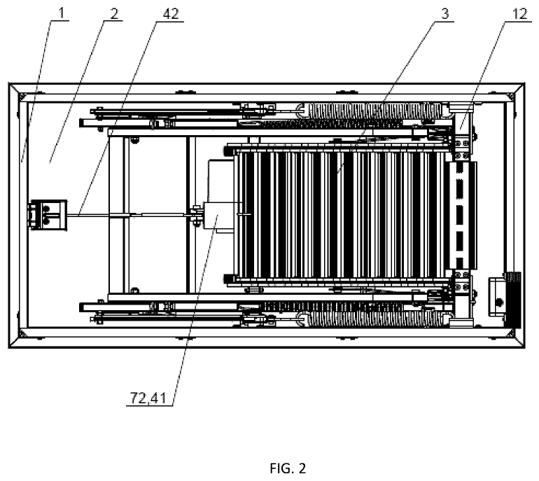

FIG. 2 top view of attic stairs after second concertina ladder hoist stage and after the closing hatch has been closed, i.e. in a folded position,

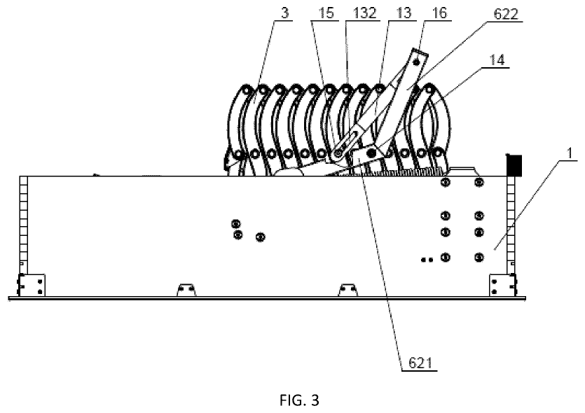

FIG. 3 side view of attic stairs after second concertina ladder hoist stage and after the closing hatch has been closed, i.e. in a folded position,

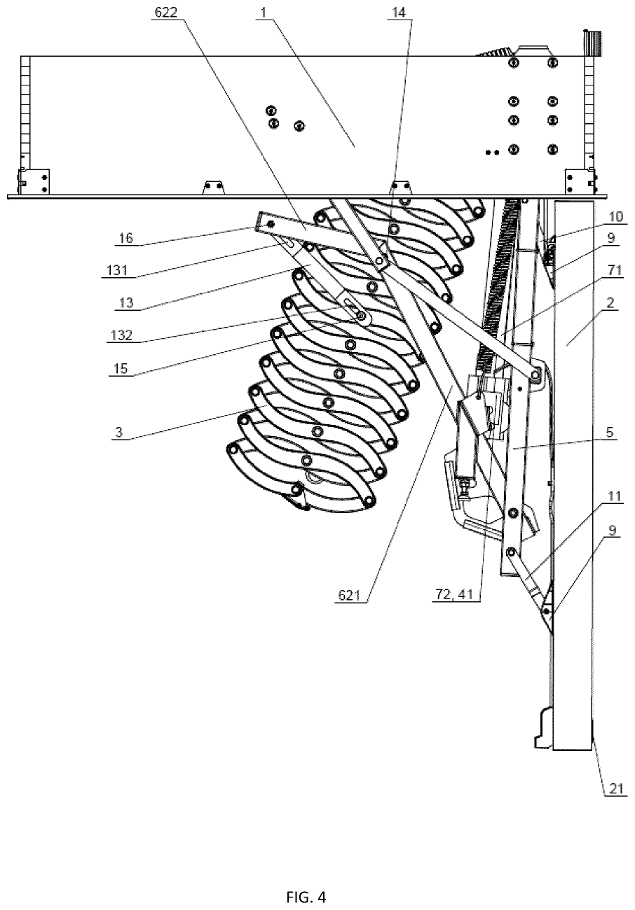

FIG. 4 attic stairs during second concertina ladder hoist stage before the closing hatch has been closed,

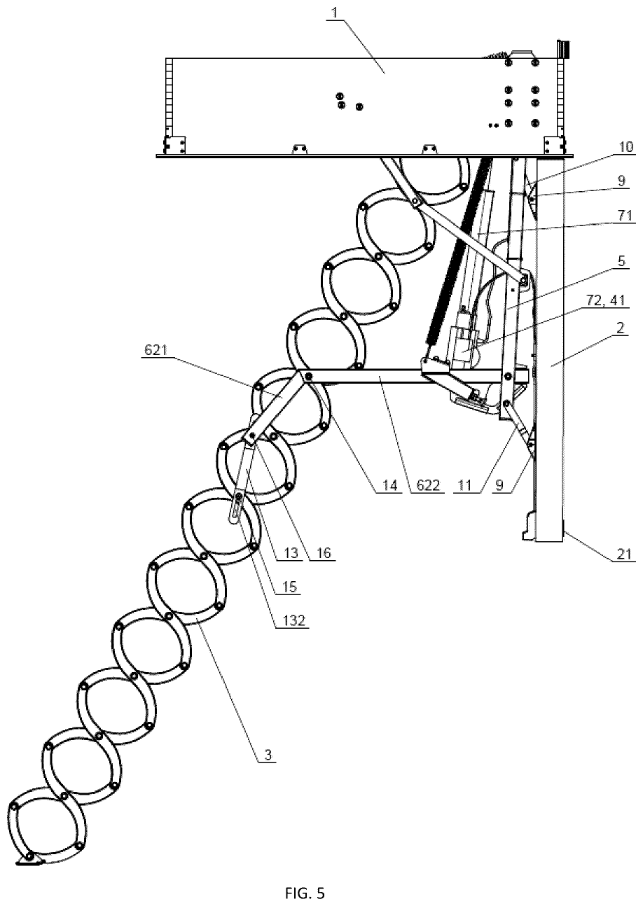

FIG. 5 attic stairs during first concertina ladder hoist stage using hoist mechanism,

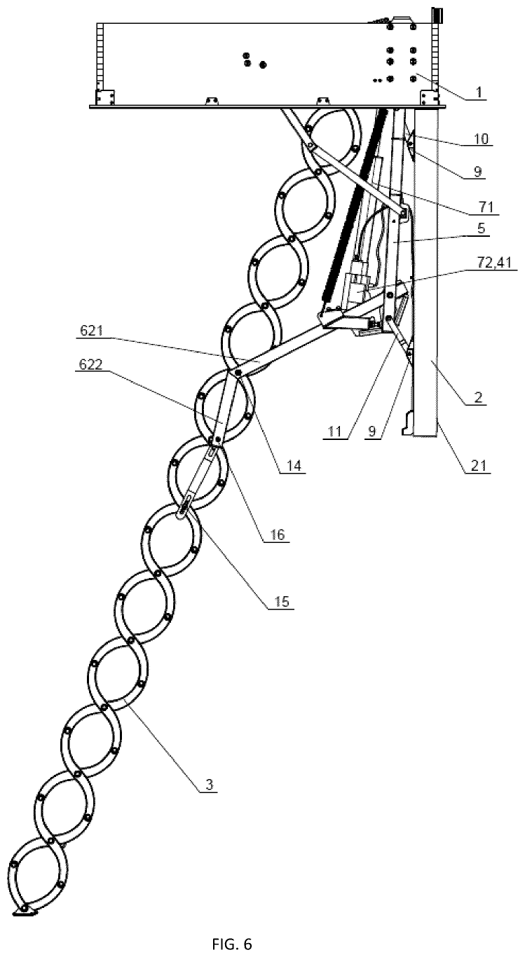

FIG. 6 attic stairs in an unfolded state, before first concertina ladder hoist stage using hoist mechanism.

The hoist mechanism according to the invention is a component element of scissor attic stairs with an electric drive. The drive assembly comprises actuator 71 driven by electric motor 72, a gear system, and drive assembly operation is controlled via a controller operated remotely. Apart from the hoist mechanism, the attic stairs feature box 1 designed to be seated in a building partition opening, closing hatch 2, concertina ladder 3. The stairs also feature a locking mechanism, which is a sub-assembly of closing hatch 2 drive assembly, which features at least coupler 41 and coupler cable 42 fastened to closing hatch bracket 21. Concertina ladder 3 is suspended from ladder base 8, wherein the ladder base is attached to box 1 side walls, and bottom box closing hatch 2 features brackets 9 for top closing hatch suspension flat bars 10 and bottom closing hatch suspension flat bars 11. Top suspension flat bars 10, with the stairs open are closer to box 1 than bottom suspension flat bars 11. The attic stairs also feature load bearing beam 12 attached to attic stairs box side walls and the drive assembly is suspended from the load bearing beam. The attic stairs hoist mechanism is attached to closing hatch 2 via a half-frame, attic stairs load bearing frame 5 and suspension flat bears 10, 11. Whereas the half-frame is constructed out of lateral stile 61 and two side stiles 62. Each half-frame side stile 62 is constructed out of two sections 621, 622 at an angle of α<180° relative to each other, and there is an articulated joint which features hoist spigot 14 between concertina ladder 3 and the half-frame. The hoist mechanism features a lifting system in the form of actuator 13, for lifting the attic stairs ladder, wherein actuator 13 assumes a passive and an active position during hoist mechanism operation. In the actuator 13 active position, its force lifting the concertina ladder is greater than zero. Extension arm 13 features two ends with longitudinal openings 131, 132 so that one end of the extension arm is attached to the half-frame side stile using spigot 16, and the other end of the extension arm is attached to the concertina ladder using support spigot 15 wherein the extension arm joints at both its ends are articulated and sliding joints. Support spigot 15 sliding motion range is determined by extension arm end longitudinal opening 132 size. Hoist spigot 14, support spigot 15, split the concertina ladder into three section which are known as section one with its lower boundary defined by hoist spigot 14, section two between hoist spigot 14, and support spigot 15 and section three with its upper boundary defined by support spigot 15. The hoist mechanism functions in such manner that once the drive assembly has been activated, concertina ladder 3 is raised towards attic stairs box 1 and is compressed. During the first hoist stage concertina ladder 3 is only raised by the hoist force acting in hoist spigot 14 leading to the greatest concertina ladder compression along concertina ladder section one. During the first stage the distance between support spigot 15 and spigot 16 changes and finally assumes a maximum value. During the second hoist stage, concertina ladder 3 compression degree along its first section and second section increases as compared to the first hoist stage, and distance between support spigot 15 and spigot 16 achieves its maximum value permissible by actuator arm 13 specification. During the second hoist stage, the lifting force resting on support spigot 15 is greater than zero, and support spigot 15 approaches hoist spigot 14 leading to concertina ladder stairs compression. After the second hoist stage, closing hatch 2 shuts box 1, leading to a complete folding of the attic stairs.

1-18. (canceled)

19. A hoist mechanism for attic stairs, the hoist mechanism comprising:
a load bearing frame;
a half-frame; and
an electric drive,
wherein:
the electric drive is suspended on the half-frame;
the half-frame includes a lateral stile and two side stiles;
the two side stiles are articulably mounted to the load bearing frame;
each of the two side stiles includes a lifting system for lifting a concertina ladder of the attic stairs; and
the lifting system is configured to, during operation of the hoist mechanism, assume a passive position and an active position.

20. The hoist mechanism of claim 19, wherein the lifting system is configured such that a force for lifting the concertina ladder of the attic stairs is greater than zero only in the active position.

21. The hoist mechanism of claim 19, wherein the lifting system is an extension arm.

22. The hoist mechanism of claim 19, further comprising an articulated joint configured to be between the half-frame and the concertina ladder of the attic stairs, wherein each of the two side stiles includes two sections at an angle of α≤180° relative to each other.

23. The hoist mechanism of claim 22, wherein the articulated joint includes a hoist spigot.

24. The hoist mechanism of claim 21, wherein a first end of the extension arm is attached to one of the two side stiles and a second end of the extension arm is configured to be attached to the concertina ladder of the attic stairs by an articulated joint.

25. The hoist mechanism of claim 24, wherein the articulated joint is a sliding joint.

26. The hoist mechanism of claim 25, wherein the sliding joint includes a support spigot.

27. The hoist mechanism of claim 26, wherein:
the support spigot is configured to travel in a longitudinal opening of the extension arm until the support spigot reaches an extreme position such that a distance changes during the operation of the hoist mechanism, the distance being between: (i) a hoist spigot of an articulated joint configured to be between the half-frame and the concertina ladder of the attic stairs; and (ii) the support spigot; and
a maximum range of change of the distance is defined by the extreme position of the support spigot in the longitudinal opening of the extension arm.

28. The hoist mechanism of claim 27, wherein the hoist spigot and the support spigot are configured to split the concertina ladder of the attic stairs into:
a first section with a lower boundary defined by the hoist spigot;
a second section between the hoist spigot and the support spigot; and
a third section with an upper boundary defined by the support spot.

29. Attic stairs comprising:
the hoist mechanism of claim 19;
a box configured to be seated in a building partition opening;
a closing hatch;
the concertina ladder;
a drive assembly;
a locking mechanism; and
a hoist mechanism,
wherein:
the concertina ladder is suspended from the load bearing frame; and
the drive assembly, the locking mechanism and the hoist mechanism are attached to the closing hatch via the half-frame and the load bearing frame.

30. The attic stairs of claim 29, wherein:
the locking mechanism is a subassembly of the drive assembly; and
the locking mechanism includes a coupler and a coupler cable fastened to a closing hatch bracket.

31. The attic stairs of claim 29, further comprising a bracket including an opening for a coupler cable terminated with a ferrule.

32. The attic stairs of claim 29, wherein:
the drive assembly includes a gear system and an actuator configured to be driven by an electric motor; and
the drive assembly is configured to be controlled via a remote controller.

33. The attic stairs of claim 29, wherein:
the concertina ladder is suspended from a ladder base;
the ladder base is attached to side walls of the box;
the closing hatch includes a first bracket for a top closing hatch suspension flat bar and a second bracket for a bottom closing hatch suspension flat bar; and
the top suspension flat bar is configured to, in an open position of the attic stairs, be closer to the box than the bottom closing hatch suspension flat bar.

34. The attic stairs of claim 29, further comprising a load bearing beam which is attached to side walls of the box, wherein the drive assembly is suspended on the load bearing beam.

35. A method of hoisting the attic stairs of claim 29, the method comprising:
preparing the attic stairs in an open position such that the concertina ladder is unfolded using the drive assembly, and the lifting system assumes any position relative to the attic stairs; and
hoisting the concertina ladder over a first hoist stage and a second hoist stage through the hoist mechanism being driven by the drive assembly,
wherein:
during the first hoist stage, the concertina ladder is raised at a support point constituting a location of a first joint between the half-frame and the concertina ladder leading to a compression of the concertina ladder whereby the compression of the concertina ladder along a first section of the concertina ladder is greatest, and a distance between a location of a second joint between one of the side stiles and the lifting system and a location of a third joint between the lifting system and the concertina ladder tends towards and achieves a maximum value permissible by a lifting system specification; and
during the second hoist stage, a compression degree of the concertina ladder along the first section and a second section increases compared to the first hoist stage, and the distance between the location of the second joint and the location of the third joint is at the maximum value as permissible by the lifting system specification.

36. The method of claim 35, further comprising, after the second hoist stage, closing the box with the closing hatch, leading to a complete folding of the attic stairs.
